(19) United States
(12) Patent Application Publication
(10) Pub. No.: US 2026/0163507 A1
(43) Pub. Date: Jun. 11, 2026

(54) Circuit Device And Motor Control System

(71) Applicant: SEIKO EPSON CORPORATION, Tokyo (JP)

(72) Inventor: Atsushi SASAKI, Chino (JP)

(21) Appl. No.: 19/413,256

(22) Filed: Dec. 9, 2025

(30) Foreign Application Priority Data
Dec. 10, 2024 (JP) 2024-215151

(51) Int. Cl. H02P 8/02

(52) U.S. Cl. CPC H02P 8/02; H02P 2205/01

(57) ABSTRACT

A circuit device includes a current detection circuit configured to detect a current flowing through a motor, and a control circuit configured to control a drive circuit configured to drive the motor based on a result of the detection performed by the current detection circuit. The control circuit includes a charge period measurement portion configured to measure a charge period in the motor driving performed by the drive circuit, and a calculation portion configured to calculate a ratio of a fast decay period to a decay period in the motor driving in accordance with the measured charge period.

The present application is based on, and claims priority from JP Application Serial Number 2024-215151, filed Dec. 10, 2024, the disclosure of which is hereby incorporated by reference herein in its entirety.

### BACKGROUND

### 1. Technical Field

The present disclosure relates to a circuit device, a motor control system, and the like.

### 2. Related Art

U.S. Patent Application Publication No. 2015/0015177 discloses an apparatus that controls a stepper motor. When the motor current exceeds a set point level after charging operation starts and then the blanking period elapses, the apparatus causes the motor drive operation to transition to a fast decay mode. When the current is lower than the set point level after the fast decay mode starts and then the blanking period elapses, the apparatus causes the motor drive operation to transition to a slow decay mode. When the motor current does not exceed the set point level after the charging operation starts and then the blanking period elapses, the apparatus keeps increasing the current and causes the motor drive operation to transition to the slow decay mode when the current reaches the set point level.

U.S. Patent Application Publication No. 2015/0015177 is an example of the related art.

In U.S. Patent Application Publication No. 2015/0015177, when the fixed blanking period has elapsed after the charging operation starts, the current flowing through the motor is compared with the set point level, and the decay control is simply switched from one to the other based on the result of the comparison, so that there is a concern that the motor current is not be appropriately controlled. For example, there is a concern that excessive decay causes insufficient suppression of the current ripple, or a concern that current waveform disturbance occurs due to insufficient decay.

### SUMMARY

An aspect of the present disclosure relates to a circuit device including: a current detection circuit configured to detect a current flowing through a motor; and a control circuit configured to control a drive circuit configured to drive the motor based on a result of the detection performed by the current detection circuit, and the control circuit includes a charge period measurement portion configured to measure a charge period in the motor driving performed by the drive circuit, and a calculation portion configured to calculate a ratio of a fast decay period to a decay period in the motor driving in accordance with the measured charge period.

Another aspect of the present disclosure relates to a motor control system including the circuit device described above and the motor.

### BRIEF DESCRIPTION OF THE DRAWINGS

FIG. 1 shows an example of the configuration of a motor control system.

FIG. 2 shows an example of a detailed configuration of a current detection circuit and a drive circuit.

FIG. 3 shows an example of a first simulated waveform of a motor current in a case where mixed decay in related art is used.

FIG. 4 shows an example of a second simulated waveform of the motor current in a case where the mixed decay in related art is used.

FIG. 5 shows an example of a detailed configuration of a control circuit in an embodiment.

FIG. 6 illustrates decay period control performed by the control circuit.

FIG. 7 shows an example of a waveform illustrating improvement in current trackability.

FIG. 8 shows an example of a waveform illustrating improvement in a current ripple.

FIG. 9 shows an example of the waveform illustrating improvement in the current ripple.

FIG. 10 shows an example of the waveform of a target current value in micro-stepping control.

FIG. 11 shows an example of the waveform of the target current value in 2-2-phase control.

FIG. 12 shows an example of the waveform illustrating an advantage provided by resetting the ratio of a fast decay period in the 2-2-phase control.

FIG. 13 shows an example of the waveform illustrating the advantage provided by resetting the ratio of the fast decay period in the 2-2-phase control.

FIG. 14 shows an example of the procedure of charge decay control including charge skipping.

FIG. 15 shows an example of a waveform illustrating improvement in the current trackability achieved by the charge skipping.

FIG. 16 is a state transition diagram in the embodiment.

FIG. 17 is a state transition diagram of the mixed decay as Comparative Example.

### DESCRIPTION OF EMBODIMENTS

Preferable embodiments of the present disclosure will be described below in detail. Note that the embodiments described below do not unduly limit the content described in the claims, and that all configurations described in the embodiments are not necessarily essential constituent requirements.

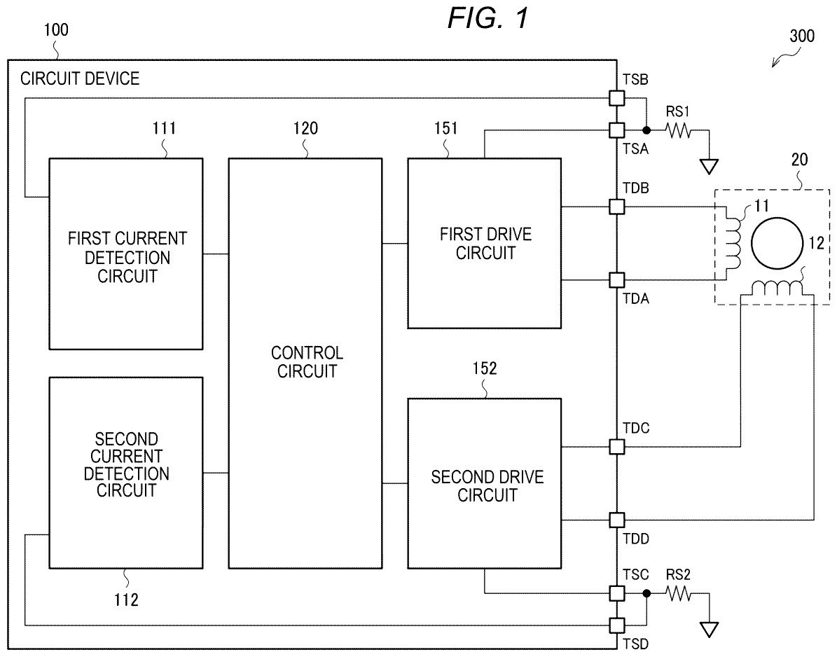

FIG. 1 shows an example of the configuration of a motor control system 300. The motor control system 300 includes a motor 20, a circuit device 100, which is a motor driver, a first sense resistor RS1, and a second sense resistor RS2. The sense resistor is also referred to as a shunt resistor. The circuit device 100 is, for example, an integrated circuit device in which multiple circuit elements are integrated in a semiconductor substrate. A case where the motor 20 is a stepper motor including a first coil 11 and a second coil 12 will be described below, and the motor 20 may instead be a multi-phase stepper motor.

The circuit device 100 includes a first drive circuit 151, which drives the first coil 11 of the motor 20, and a first current detection circuit 111, which detects a first current flowing through the first sense resistor RS1. The circuit device further includes a terminal TSA, a terminal TSB, a terminal TDA, and a terminal TDB. The terminal TSA is coupled to one end of the first sense resistor RS1 and the first drive circuit 151. The terminal TSB is coupled to the one end of the first sense resistor RS1 and the first current detection circuit 111. The terminal TDA is coupled to one end of the first coil 11 and the first drive circuit 151. The terminal TDB is coupled to the other end of the first coil 11 and the first drive circuit 151.

The circuit device 100 further includes a second drive circuit 152, which drives the second coil 12 of the motor 20, and a second current detection circuit 112, which detects a second current flowing through the second sense resistor RS2. The circuit device further includes a terminal TSC, a terminal TSD, a terminal TDC, and a terminal TDD. The terminal TSC is coupled to one end of the second sense resistor RS2 and the second drive circuit 152. The terminal TSD is coupled to the one end of the second sense resistor RS2 and the second current detection circuit 112. The terminal TDC is coupled to one end of the second coil 12 and the second drive circuit 152. The terminal TDD is coupled to the other end of the second coil 12 and the second drive circuit 152.

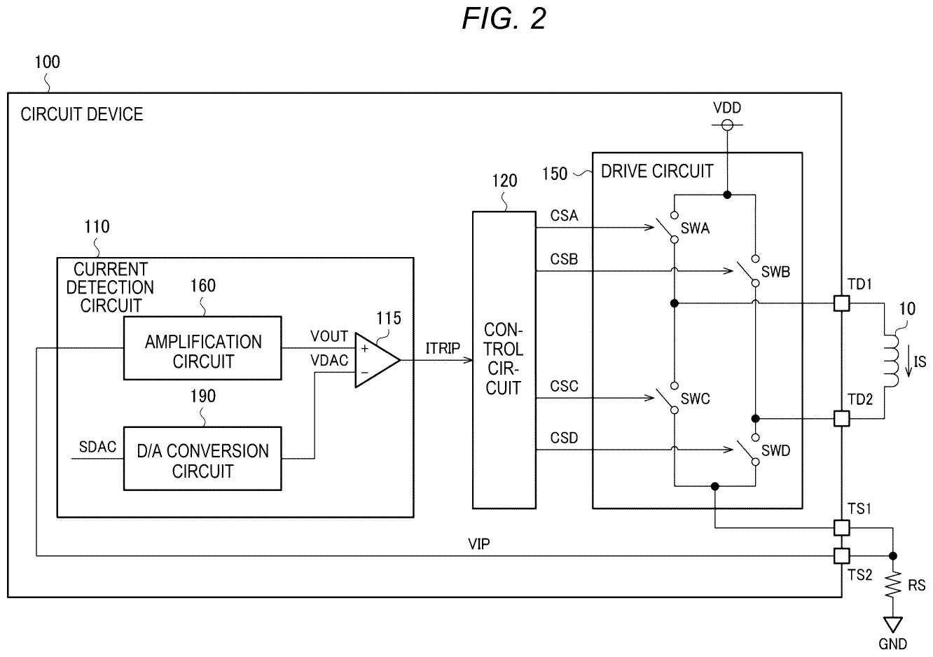

FIG. 2 shows an example of a detailed configuration of a current detection circuit 110 and a drive circuit 150. The current detection circuit 110, the drive circuit 150, a coil 10, and a sense resistor RS in FIG. 2 correspond to the first current detection circuit 111, the first drive circuit 151, the first coil 11, and the first sense resistor RS1 in FIG. 1, or correspond to the second current detection circuit 112, the second drive circuit 152, the second coil 12, and the second sense resistor RS2 in FIG. 1. Terminals TD1, TD2, TS1, and TS2 in FIG. 2 correspond to the terminals TDA, TDB, TSA, and TSB in FIG. 1, or correspond to the terminals TDC, TDD, TSC, and TSD in FIG. 1.

The current detection circuit 110 detects whether an input voltage VIP from the terminal TS2 exceeds a voltage corresponding to a target current value, and outputs a current detection signal ITRIP, which is the result of the detection. The input voltage VIP is a voltage corresponding to a current flowing through the sense resistor RS, and VIP=RS×IS is satisfied in a charge period. IS represents the current flowing through the coil and is equivalent to the current flowing through the sense resistor RS. The current IS may be hereinafter referred to as a motor current. The current detection circuit 110 includes an amplification circuit 160, a D/A conversion circuit 190, and a comparator 115.

The amplification circuit 160 amplifies the input voltage VIP and outputs the amplified voltage as an output voltage VOUT. The amplification circuit 160 is, for example, a non-inverting amplification circuit configured with an operational amplifier and a resistor.

The D/A conversion circuit 190 converts instruction data SDAC, which indicates the target current value, from a digital value into an analog value, and outputs the result of the conversion as an output voltage VDAC. The D/A conversion circuit 190 includes, for example, a ladder resistor circuit and a selection circuit. The ladder resistor circuit divides a power supply voltage VDD into multiple voltages. The selection circuit selects a voltage corresponding to the instruction data SDAC from the multiple voltages, and outputs the selected voltage as the output voltage VDAC. The instruction data SDAC is written, for example, to a register that is not shown but is provided in the circuit device 100 from a processing device outside the circuit device 100.

The output voltage VOUT from the amplification circuit 160 is input to a first input terminal of the comparator 115, and the output voltage VDAC from the D/A conversion circuit 190 is input to a second input terminal of the comparator 115. The comparator 115 compares the output voltage VOUT from the amplification circuit 160 with the output voltage VDAC from the D/A conversion circuit 190, and outputs the result of the comparison as the current detection signal ITRIP. In the example shown in FIG. 2, the first input terminal is the positive polarity input terminal, and the second input terminal is the negative polarity input terminal, and may be vice versa.

The drive circuit 150 is an H-bridge circuit and includes switch elements SWA to SWD. One end of the switch element SWA is coupled to a power supply node to which the power supply voltage VDD is supplied, and the other end of the switch element SWA is coupled to the terminal TD1. One end of the switch element SWB is coupled to the power supply node, and the other end of the switch element SWB is coupled to the terminal TD2. One end of the switch element SWC is coupled to the terminal TD1, and the other end of the switch element SWC is coupled to the terminal TS1. One end of the switch element SWD is coupled to the terminal TD2, and the other end of the switch element SWD is coupled to the terminal TS1. The switch element SWA is turned on or off by a preliminary drive signal CSA from a control circuit 120. Similarly, the switch elements SWB, SWC, and SWD are turned on or off by preliminary drive signals CSB, CSC, and CSD from the control circuit 120. The switch elements SWA and SWB are each a high-side transistor, for example, a P-type MOS transistor or an N-type MOS transistor. The switch elements SWC and SWD are each a low-side transistor, for example, an N-type MOS transistor.

The control circuit 120 outputs the preliminary drive signals CSA, CSB, CSC, and CSD, which switch the switch elements in the drive circuit 150 from on to off and vice versa based on the current detection signal ITRIP. It is assumed that the direction of the arrow attached to the coil 10 in FIG. 2 is the positive direction of the current IS. When a positive current IS flows, the control circuit 120 turns on the switch elements SWA and SWD and turns off the switch elements SWB and SWC in a charging operation. In a fast decay mode, the control circuit 120 turns on the switch elements SWB and SWC, and turns off the switch elements SWA and SWD. In a slow decay mode, the control circuit 120 turns on the switch elements SWC and SWD, and turns off the switch elements SWA and SWB. On the other hand, when a negative current IS flows, the control circuit 120 turns on the switch elements SWB and SWC, and turns off the switch elements SWA and SWD in the charging operation. In the fast decay mode, the control circuit 120 turns on the switch elements SWA and SWD, and turns off the switch elements SWB and SWC. In the slow decay mode, the control circuit 120 turns on the switch elements SWC and SWD, and turns off the switch elements SWA and SWB.

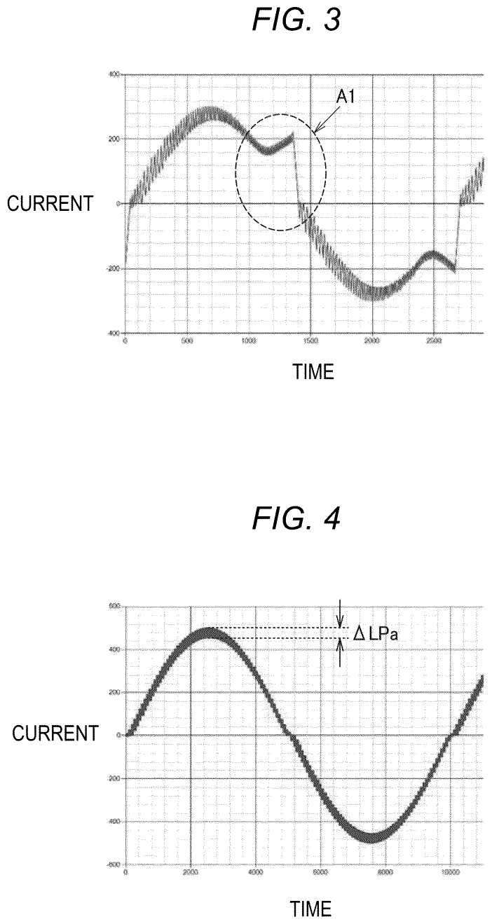

FIG. 3 shows an example of a first simulated waveform of the motor current in a case where mixed decay in related art is used. In the mixed decay mode, both the fast decay mode and the slow decay mode are performed, and the period of the fast decay mode and the period of the slow decay mode are fixed. FIG. 3 shows a signal waveform of a current flowing through a coil of an HB motor in micro-stepping control at 1500 pps. The value along the horizontal axis is expressed in μsec, and the value along the vertical axis is expressed in mA.

The target current value is derived from a waveform that is an approximate sine wave formed by the micro-stepping control. The current flowing through the coil is ideally a sine wave as a result of tracing the sine wave representing the target current value. However, when the absolute value of the target current value decreases, the motor current deviates from the target current due to the counter electromotive force produced by the motor, as shown by the current waveform in the portion indicated by the dotted circle A1. Since the counter electromotive force increases as the rotational speed of the motor increases, the deviation described above is likely to occur. When such disturbance of the current waveform occurs, the vibration of the motor increases, and the motor is likely to be out of step, or the noise of the motor increases.

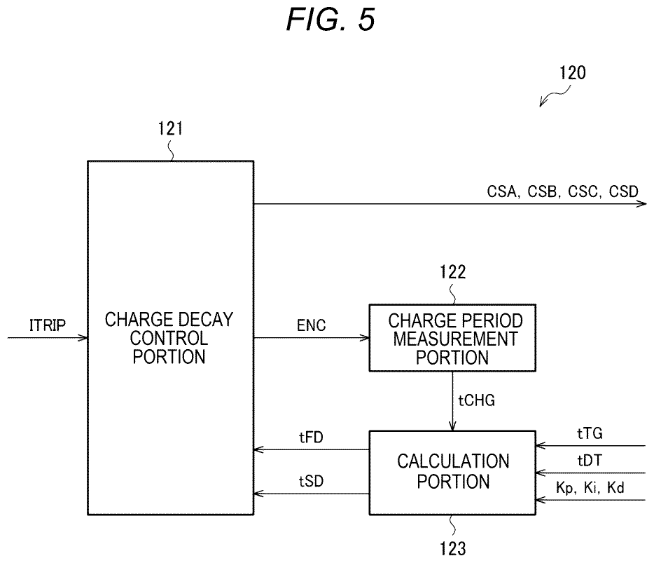

FIG. 4 shows an example of a second simulated waveform of the motor current in a case where the mixed decay in related art is used. FIG. 4 shows a signal waveform of the current flowing through the coil of the HB motor in the micro-stepping control at 400 pps. The value along each of the axes is expressed in the same unit as in FIG. 3.

In FIG. 4, no current waveform disturbance occurs because the rotational speed is low. In the mixed decay mode, however, since the period of the fast decay mode is fixed, excessive decay and charging are performed, so that a current ripple ΔLPa increases. Since the energy of the coil is discharged in the decay, a large quantity of decay discharges extra energy. Therefore, current consumption increases to charge the discharged energy, or discharging extra energy increases the amount of generated heat. Furthermore, since the torque is controlled by the motor current, a large ripple increases torque fluctuation.

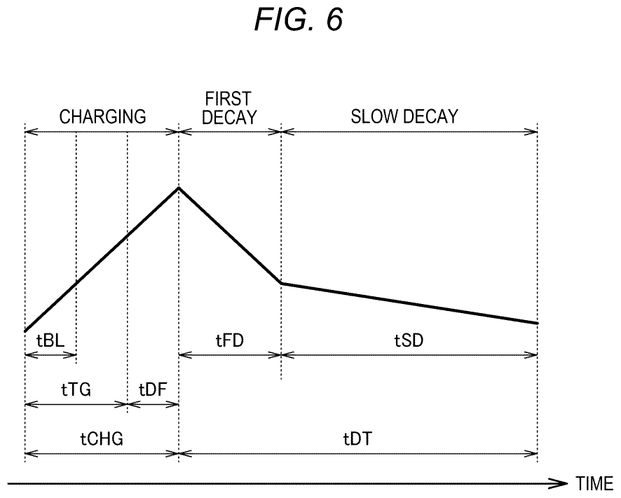

In view of the facts described above, in the present embodiment, the control circuit 120 changes the ratio of the fast decay period to the decay period in accordance with the charge period. FIG. 5 shows an example of a detailed configuration of the control circuit 120 in the present embodiment. The control circuit 120 includes a charge decay control portion 121, a charge period measurement portion 122, and a calculation portion 123. FIG. 6 illustrates decay period control performed by the control circuit 120.

The charge decay control portion 121 controls the preliminary drive signals CSA, CSB, CSC, and CSD to cause the drive circuit 150 to perform the charging, the fast decay, or the slow decay. The on/off states of the switch elements SWA, SWB, SWC, and SWD in each of the states described above, the charging, the fast decay, or the slow decay, have been described above.

After starting the charging, the charge decay control portion 121 maintains the charging during at least a blanking period tBL. After the blanking period tBL elapses, when the current detection signal ITRIP changes from the low level to the high level, that is, when it is detected that the current IS flowing through the coil 10 has reached the target current value, the charge decay control portion 121 ends the charging.

The charge decay control portion 121 switches a charge enable signal ENC from disabled to enabled when the charging starts, and switches the charge enable signal ENC from enabled to disabled when the charging ends. The charge period measurement portion 122 measures the period for which the charge enable signal ENC is enabled as a charge period tCHG. For example, the charge period measurement portion 122 is a counter, and measures the charge period tCHG by performing counting when the charge enable signal ENC is enabled.

The calculation portion 123 determines a fast decay period tFD and a slow decay period tSD by performing PID control in accordance with the charge period tCHG.

Specifically, the calculation portion 123 calculates a difference tDF between the charge period tCHG and a target period tTG based on Expressions (1) and (2) below. The blanking period tBL and a set value tSET are preset values. As an example, the blanking period tBL and the set value tSET are both 1 μsec, but are not limited thereto.

$$tDF = tTG - tCHG \qquad ( 1 )$$

$$tTG = tBL + tSET \qquad ( 2 )$$

The calculation portion 123 uses the difference tDF to calculate a ratio FastRatio of the fast decay period tFD to a decay period tDT based on Expressions (3) to (6) below. n is a number indicating a calculation timing along the timeline. Kp, Ki, and Kd are gains in respective terms in the PID control, and are set in advance. The symbol * represents multiplication. k represents the number of stages of a FIFO memory that temporarily stores dataP.

$$FastRatio ( n ) = FastRatio ( n - 1 ) + ( Kp * dataP ( n ) + ( Ki * dataI ( n ) + ( Kd * dataD ( n ) ) \qquad ( 3 )$$

$$dataP ( n ) = tDF / tDT \qquad ( 4 )$$

$$dataI ( n ) = dataP ( n ) + dataP ( n - 1 ) + … + dataP ( n - k - 1 ) \qquad ( 5 )$$

$$dataD ( n ) = dataP ( n - 1 ) - dataP ( n ) \qquad ( 6 )$$

The calculation portion 123 uses the ratio FastRatio(n) to calculate the fast decay period tFD and the slow decay period tSD based on Expressions (7) and (8) below. The decay period tDT is a preset value.

$$tFD = tDT * FastRatio ( n ) \qquad ( 7 )$$

$$tSD = tDT - tFD \qquad ( 8 )$$

The target period tTG, the decay period tDT, and the gains Kp, Ki, and Kd are set in, for example, a register that is not shown in the circuit device 100 from a processing device outside the circuit device 100, or are stored in advance in a nonvolatile memory that is not shown but is provided in the circuit device 100.

The charge decay control portion 121 starts the fast decay, starts the slow decay after the fast decay period tFD elapses, and starts the charging again after the slow decay period tSD elapses. Thereafter, the same decay period control is repeated.

According to the PID control described above, the ratio FastRatio of the fast decay period tFD is adaptively controlled in accordance with the charge period tCHG. That is, when the motor current is significantly lower than the target current value, the charge period tCHG increases, so that the fast decay period tFD decreases. Conversely, when the difference between the motor current and the target current value is small, the charge period tCHG decreases, so that the fast decay period tFD increases. Trackability showing how precisely the motor current tracks the target current value is thus improved, so that the current waveform disturbance described above can be reduced. Furthermore, the fast decay period tFD is not fixed, so that the current ripple can be reduced.

Note that the calculation portion 123 may calculate the ratio FastRatio(n) by performing PD control, as shown in Expression (9) below. The same advantages described above can be provided also by the PD control.

$$FastRatio ( n ) = FastRatio ( n - 1 ) + Kp * dataP ( n ) + Kd * dataD ( n ) \qquad ( 9 )$$

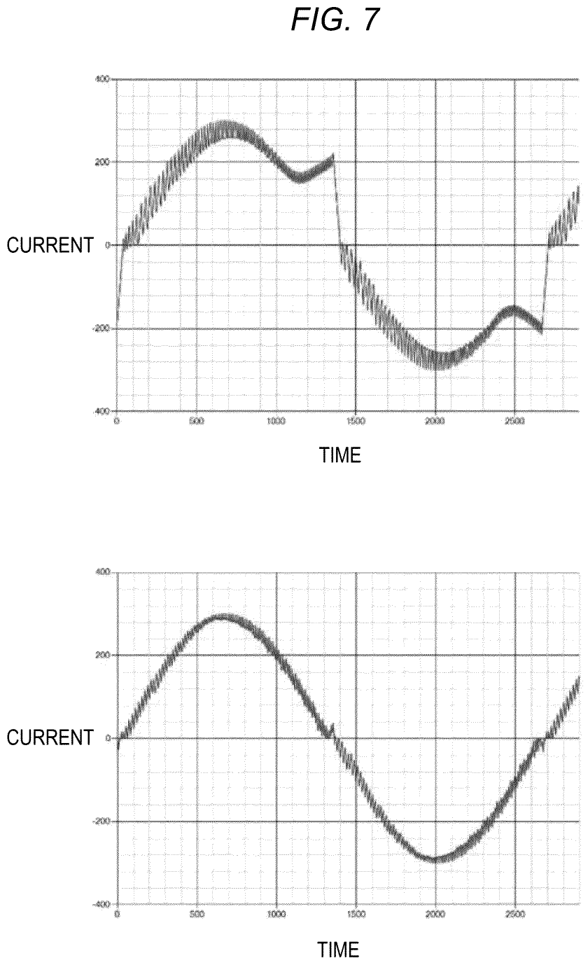

FIG. 7 shows an example of a waveform illustrating improvement in the current trackability. FIG. 7 shows a signal waveform of the current flowing through the coil of the HB motor in the micro-stepping control at 1500 pps. The value along each of the axes is expressed in the same unit as in FIG. 3. The upper portion shows an example of a simulated waveform of the motor current in a case where the mixed decay in related art is used, and is the same as FIG. 3. The lower portion shows an example of a simulated waveform of the motor current in the case where the PID control in the present embodiment is performed.

The induced current generated in the motor by the counter electromotive force cannot be fully attenuated by the fast decay and the slow decay, so that the current waveform disturbance shown in the upper portion occurs. According to the present embodiment, when the motor current is likely to be greater than the target current value, the charge period shortens, so that the ratio of the fast decay period is increased by the PID control. The induced current generated in the motor can thus be attenuated, so that the trackability showing how precisely the motor current tracks the target current value is improved, as shown in the lower portion.

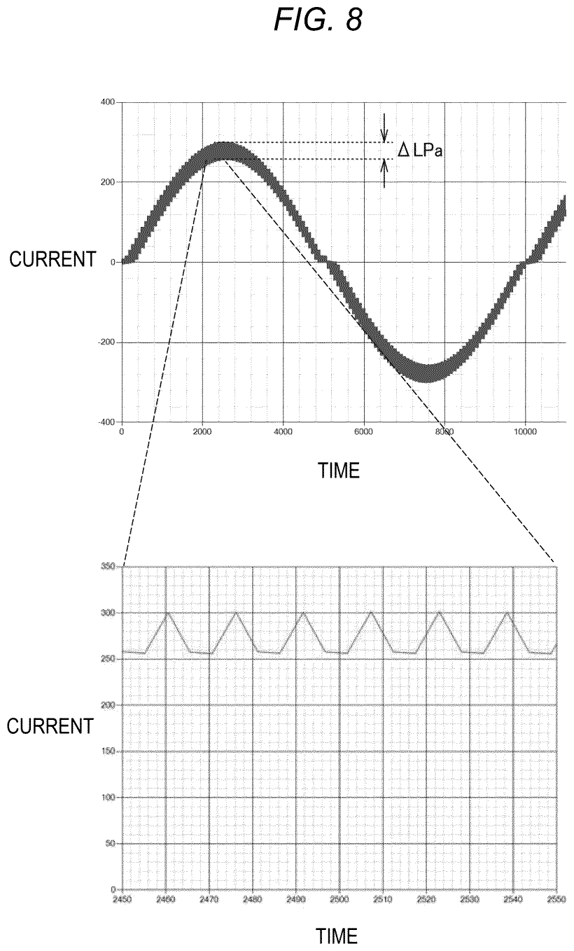

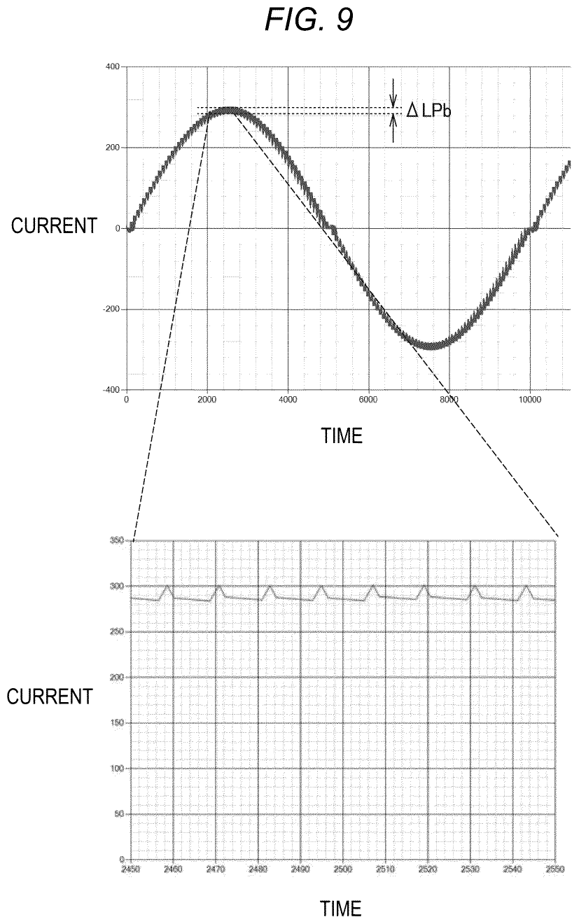

FIGS. 8 and 9 show examples of a waveform illustrating improvement in the current ripple. FIGS. 8 and 9 show signal waveforms of the current flowing through the coil of the HB motor in the micro-stepping control at 400 pps. The value along each of the axes is expressed in the same unit as in FIG. 3. FIG. 8 is an example of a simulated waveform in the case where the mixed decay in related art is used. The lower portion is an enlarged view of a portion of the upper portion. FIG. 9 is an example of a simulated waveform in the case where the PID control in the present embodiment is performed. The lower portion is an enlarged view of a portion of the upper portion.

Since the fast decay period is fixed in the mixed decay, the mixed decay is so set that a necessary fast decay period can be ensured under the most demanding decay conditions. Therefore, under decay conditions that are less stringent, excessive fast decay occurs, resulting in a larger current drop, which is repeatedly compensated by the charging. The current ripple ΔLPa therefore increases in the mixed decay, as shown in FIG. 8. According to the present embodiment, since the ratio of the fast decay period is optimized by the PID operation, an appropriate fast decay period is provided even under decay conditions that are and are not stringent. Under decay conditions that are not stringent, the slow decay period prolongs, and the current drop is small. Therefore, in the present embodiment, the current ripple ΔLPb decreases, as shown in FIG. 9.

An embodiment described below may be further added to the embodiment described above with reference to FIGS. 1 to 9.

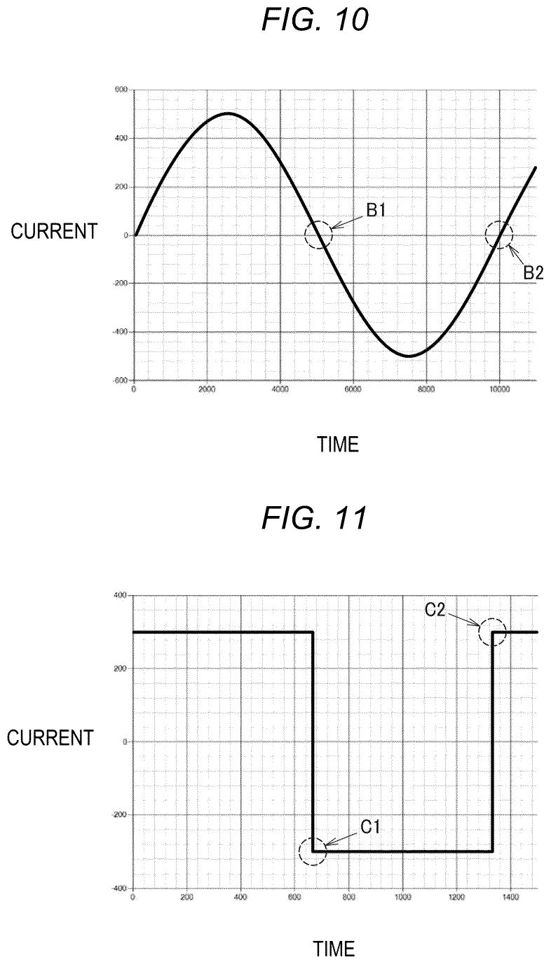

An embodiment in which the ratio FastRatio(n) of the fast decay period tFD is reset will be described with reference to FIGS. 10 to 13.

FIG. 10 shows an example of the waveform of the target current value in the micro-stepping control. In FIG. 10, the target current value is indicated by a sine wave, which is in practice an approximate sine wave produced by discretely changing the target current value based on the micro-stepping. In the present embodiment, the instruction data SDAC indicating the target current value is further input to the calculation portion 123. The calculation portion 123 resets the ratio FastRatio(n) of the fast decay period tFD to an initial value in the first PID operation after the target current value crosses zero, as indicated by the dotted circles B1 and B2. Specifically, when the PID operation is performed for the first time after the target current value changes from zero to a non-zero value, the calculation portion 123 uses a predetermined initial value as the ratio FastRatio(n) instead of determining the ratio FastRatio(n) based on Expression (3) described above. In the micro-stepping control, the initial value is, for example, 0%.

In the micro-stepping control, the fast decay period tFD is short before the target current value becomes zero because the absolute value of the target current value decreases, whereas the fast decay time tFD is long after the target current value crosses zero because the absolute value of the target current value increases. That is, the tendency of the ratio FastRatio(n) changes at the timing when the target current value becomes zero. Resetting the ratio FastRatio(n) instead of using Expression (3) described above at such a boundary allows quick tracking of the aforementioned change in the tendency, so that the trackability showing how precisely the motor current tracks the target current value is further improved.

FIG. 11 shows an example of the waveform of the target current value in 2-2-phase control. In this example, the instruction data SDAC indicating the target current value is further input to the calculation portion 123. In the 2-2-phase control, there are only two types of target current values: a positive value; and a negative value. The calculation portion 123 resets the ratio FastRatio(n) of the fast decay period tFD to the initial value in the first PID operation after the target current value crosses zero, as indicated by the dotted circles C1 and C2. Specifically, when the PID operation is performed for the first time after the target current value changes from a positive value to a negative value or vice versa, the calculation portion 123 uses the predetermined initial value as the ratio FastRatio(n) instead of determining the ratio FastRatio(n) based on Expression (3) described above. In the micro-stepping control, the initial value is a value greater than zero, for example, 25%. Note that the same resetting can be applied to 1-2-phase control.

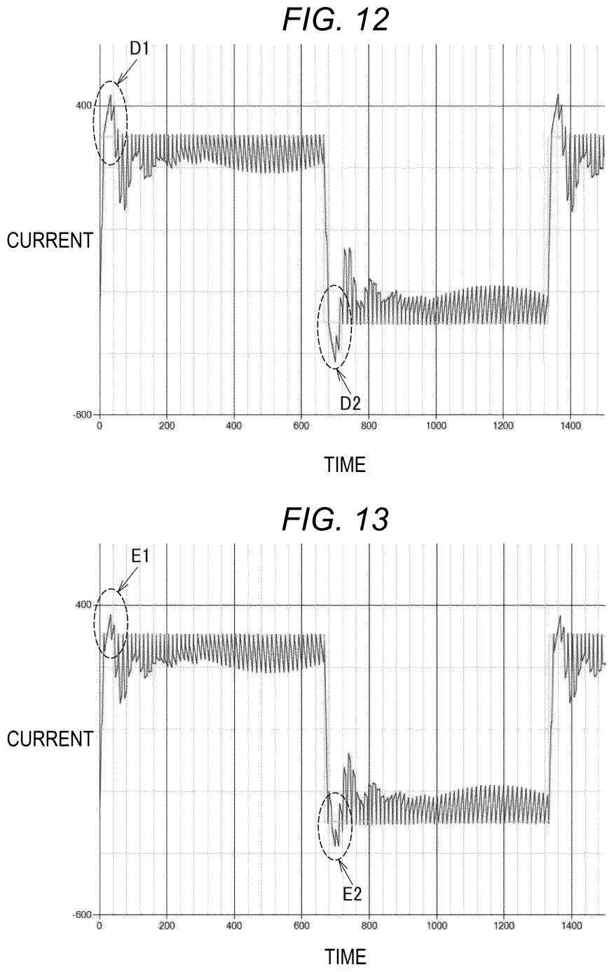

FIGS. 12 and 13 show examples of the waveform illustrating an advantage provided by resetting the ratio of the fast decay period in the 2-2-phase control. The value along each of the axes is expressed in the same unit as in FIG. 3. FIG. 12 shows an example of a simulated waveform of the motor current in a case where the resetting is not performed, and FIG. 13 shows an example of a simulated waveform of the motor current in a case where the resetting is performed.

In the 2-2-phase control, when the target current value is switched from a positive value to a negative value or vice versa, the charging that reverses the direction of the motor current is performed for a long period. In this process, since the charge period tCHG is very long, the fast decay period tFD determined by Expression (3) described above becomes long, so that there is a possibility of excessively performed fast decay. The excessive fast decay increases the motor current to have a value beyond the target current value, as indicated by the dotted circles D1 and D2 in FIG. 12. According to the present embodiment, resetting the ratio FastRatio(n) at the timing when the target current value crosses zero provides an appropriate fast decay period. After the target current value is switched from a positive value to a negative value or vice versa, the target current value is fixed, and a certain length of fast decay period is therefore required, so that the reset ratio FastRatio is set to have a value greater than zero. The deviation of the motor current from the target current value is reduced by resetting the ratio of the fast decay period, as indicated by the dotted circles E1 and E2 in FIG. 13.

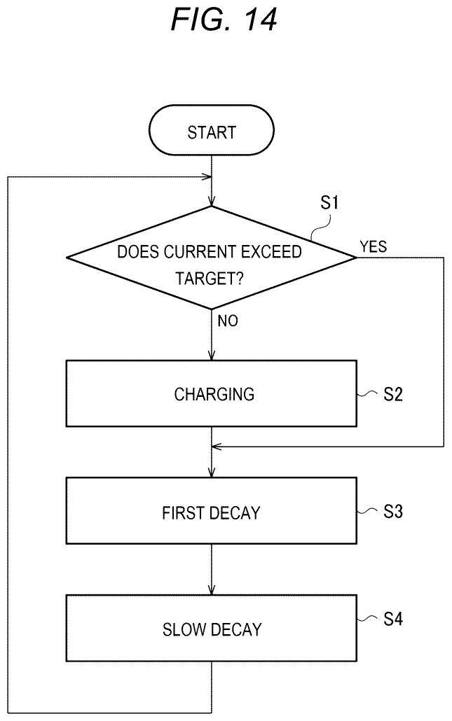

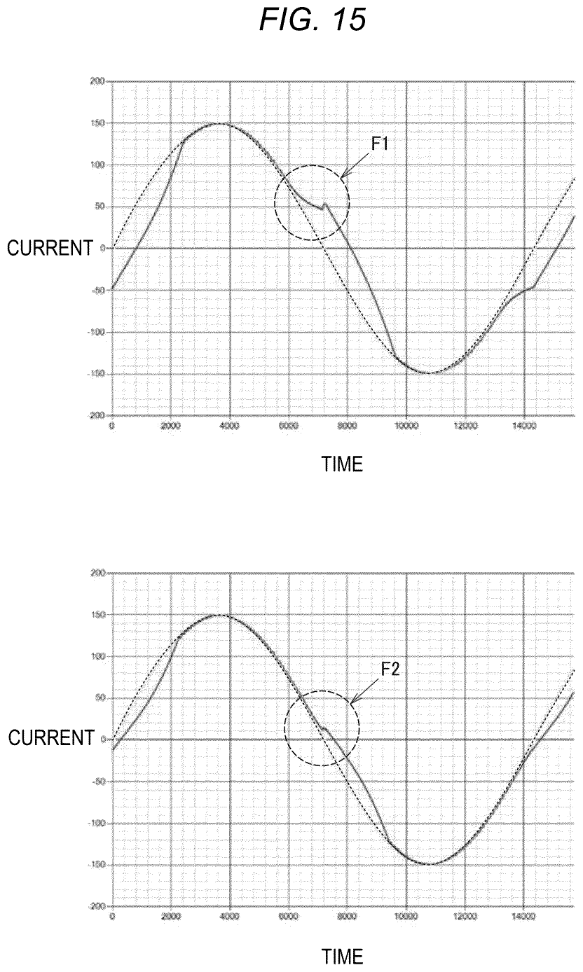

An embodiment in which charge skipping is performed will be described with reference to FIGS. 14 and 15.

FIG. 14 shows an example of the procedure of charge decay control including the charge skipping. In step S1, the charge decay control portion 121 determines whether the motor current exceeds the target current value before the charging starts.

When the motor current does not exceed the target current value in step S1, the charge decay control portion 121 performs the charging in step S2. When the motor current exceeds the target current value as a result of the charging, the charge decay control portion 121 performs the PID control to determine the ratio FastRatio, performs the fast decay in step S3 and the slow decay in step S4, and returns to step S1.

When the motor current exceeds the target current value in step S1, the charge decay control portion 121 skips the charging in step S2, performs the PID control with the charge period tCHG set at zero, and determines the ratio FastRatio. The charge decay control portion 121 performs the fast decay in step S3 and the slow decay in step S4, and returns to step S1.

FIG. 15 shows an example of a waveform illustrating improvement in the current trackability achieved by the charge skipping. FIG. 15 shows a signal waveform of the current flowing through a coil of a PM motor in the micro-stepping control at 280 pps. The value along each of the axes is expressed in the same unit as in FIG. 3. The solid line indicates the waveform of the motor current, and the dotted line indicates the waveform of the target current value. The target current value is indicated by a sine wave, which is actually a waveform that is an approximate sine wave achieved by the micro-stepping. The upper portion of FIG. 15 shows an example of a simulated waveform in a case where the charge skipping is not performed. The lower portion of FIG. 15 shows an example of a simulated waveform in a case where the charge skipping is performed.

In the mixed decay, since the charging is performed at least for the blanking period tBL, charge is always generated even when the motor current exceeds the target current value. Therefore, when the absolute value of the target current value decreases, the trackability showing how precisely the motor current tracks the target current value deteriorates, as indicated by the dotted circle F1 in the upper portion of FIG. 15. According to the present embodiment, in a situation in which the motor current exceeds the target current value, the PID operation makes the fast decay period zero because the charge period shortens. Skipping the charging using the feature described above causes the charging not to be performed by only the decay to be performed. The trackability showing how precisely the motor current tracks the target current value can thus be improved, as indicated by the dotted circle F2 in the lower portion of FIG. 15.

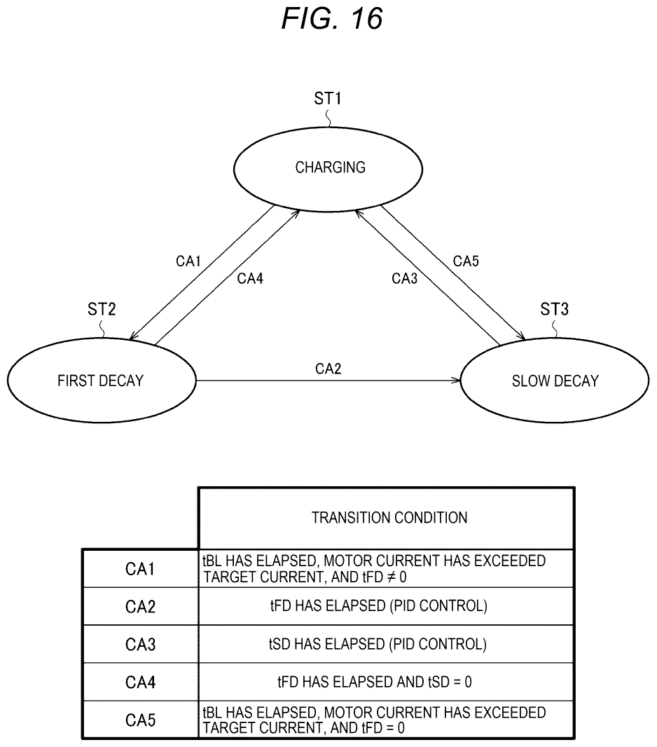

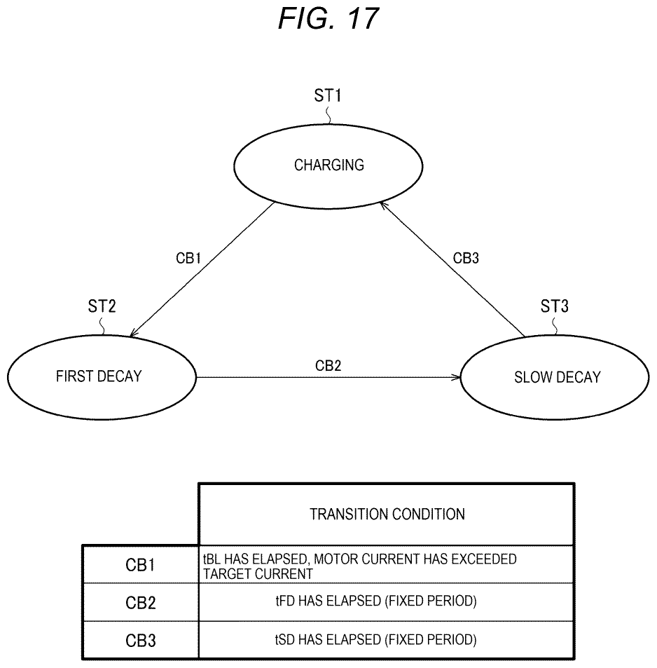

An embodiment in which the fast decay or the slow decay is skipped will be described with reference to FIGS. 16 and 17.

FIG. 16 is a state transition diagram in the present embodiment. When a condition CA1 is satisfied in the charging in a state ST1, the charge decay control portion 121 transitions to the fast decay in a state ST2. The condition CA1 is a condition that the blanking period tBL has elapsed, the motor current has exceeded the target current value, and the fast decay period tFD is not zero.

When a condition CA2 is satisfied in the fast decay in the state ST2, the charge decay control portion 121 transitions to the slow decay in a state ST3. The condition CA2 is a condition that the fast decay period tFD provided by the PID operation has elapsed.

When a condition CA3 is satisfied in the slow decay in the state ST3, the charge decay control portion 121 transitions to the charging in the state ST1. The condition CA3 is a condition that the slow decay period tSD provided by the PID operation has elapsed.

When a condition CA4 is satisfied in the fast decay in the state ST2, the charge decay control portion 121 skips the slow decay in the state ST3 and transitions to the charging in the state ST1. The condition CA4 is a condition that the fast decay period tFD provided by the PID operation has elapsed and the slow decay period tSD provided by the PID operation is zero. In this case, the ratio FastRatio is 100%, and the fast decay period tFD is equal to the decay period tDT.

When a condition CA5 is satisfied in the charging in the state ST1, the charge decay control portion 121 skips the fast decay in the state ST2 and transitions to the slow decay in the state ST3. The condition CA5 is a condition that the blanking period tBL has elapsed, the motor current has exceeded the target current value, and the fast decay period tFD is zero. In this case, the ratio FastRatio is 0%, and the slow decay period tSD is equal to the decay period tDT.

FIG. 17 is a state transition diagram of the mixed decay as Comparative Example. When a condition CB1 is satisfied in the charging in the state ST1, the charge decay control portion 121 transitions to the fast decay in the state ST2. The condition CB1 is a condition that the blanking period tBL has elapsed, and the motor current has exceeded the target current value.

When a condition CB2 is satisfied in the fast decay in the state ST2, the charge decay control portion 121 transitions to the slow decay in the state ST3. The condition CB2 is a condition that the fixed fast decay period tFD has elapsed.

When a condition CB3 is satisfied in the slow decay in the state ST3, the charge decay control portion 121 transitions to the charging in the state ST1. The condition CB3 is a condition that the fixed slow decay period tSD has elapsed.

Since the fast decay and the slow decay are always performed in the mixed decay, there is a concern that the decay is excessive or insufficient. According to the present embodiment in FIG. 16, since the fast decay or the slow decay is adaptively skipped based on the PID control, the amount by which the decay is excessive or insufficient can be reduced. Therefore, the trackability showing how precisely the motor current tracks the target current value can be further improved, or the current ripple can be further reduced.

In the present embodiment described above, the circuit device 100 includes the current detection circuit 110, which detects the current IS flowing through the motor 20, and the control circuit 120, which controls the drive circuit 150, which drives the motor 20, based on the result of the detection performed by the current detection circuit 110. The control circuit 120 includes the charge period measurement portion 122, which measures the charge period tCHG in the motor driving performed by the drive circuit 150, and the calculation portion 123, which calculates the ratio FastRatio of the fast decay period tFD to the decay period tDT in the motor driving in accordance with the measured charge period tCHG.

According to the present embodiment, the fast decay period tFD is adaptively controlled in accordance with the charge period tCHG. The amount by which the decay is excessive or insufficient can thus be reduced, so that the trackability showing how precisely the motor current tracks the target current value is improved, or the current ripple is reduced.

As described with reference to Expressions (1) to (9) described above, the calculation portion 123 may increase the ratio FastRatio of the fast decay period tFD as the charge period tCHG shortens.

When the current IS flowing through the motor 20 is close to or exceeds the target current value, the charge period tCHG shortens. In this case, increasing the fast decay period tFD allows the fast decay to attenuate the induced current in the motor 20. The trackability showing how precisely the motor current tracks the target current value is thus improved.

As described with reference to Expressions (1) to (9) described above, the calculation portion 123 may calculate the ratio FastRatio of the fast decay period tFD in accordance with the difference tDF between the charge period tCHG and the target period tTG.

According to the present embodiment, when the charge period tCHG deviates from the target period tTG, increasing or decreasing the ratio FastRatio of the fast decay period tFD allows the charge period tCHG to converge to the target period tTG. Performing such adaptive control of the fast decay period tFD improves the trackability showing how precisely the motor current tracks the target current value, or reduces the current ripple.

As described with reference to Expressions (1) to (9) described above, the calculation portion 123 may calculate the ratio FastRatio of the fast decay period tFD in accordance with the difference tDF and a change in the difference tDF. Note in the examples of Expressions (1) to (9) described above that dataD corresponds to the “change in the difference tDF”.

According to the present embodiment, the fast decay period tFD and the slow decay period tSD can be determined by the PD control based on the charge period tCHG.

As described with reference to Expressions (1) to (8) described above, the calculation portion 123 may calculate the ratio FastRatio of the fast decay period tFD in accordance with the difference tDF, an accumulated value of the difference tDF, and a change in the difference tDF. Note in the examples of Expressions (1) to (8) described above that dataI corresponds to the “accumulated value of the difference tDF”.

According to the present embodiment, the fast decay period tFD and the slow decay period tSD can be determined by the PID control based on the charge period tCHG.

As described with reference to Expressions (1) to (9) described above, the calculation portion 123 may determine the amount of change in the ratio FastRatio of the fast decay period tFD from the charge period tCHG at the end of the motor driving charging, and update the ratio FastRatio by adding the amount of change to the previous ratio FastRatio. The “amount of change in the ratio FastRatio” corresponds to the second to fourth terms on the right side in the example of Expression (3) described above, and corresponds to the second and third terms on the right side in the example of Expression (9) described above.

According to the present embodiment, the amount of change in the ratio FastRatio of the fast decay period tFD is determined based on the charge period tCHG, and updating the ratio FastRatio by the amount of change allows the ratio FastRatio to be calculated in accordance with the charge period tCHG.

As described with reference to FIGS. 10 to 13, the calculation portion 123 may reset the ratio FastRatio of the fast decay period tFD to the initial value when the target current value of the current IS flowing through the motor 20 crosses zero. Note that the state in which the target current value “crosses zero” means that the target current value changes from zero to a positive or negative value, from a positive value to a negative value, or from a negative value to a positive value.

When the target current value crosses zero, a necessary amount of the fast decay greatly changes before and after the zero crossing, so that there is a concern that the trackability showing how precisely the motor current tracks the target current value deteriorates. According to the present embodiment, when the target current value crosses zero, the previous ratio FastRatio is not updated by the amount of change but is reset to the initial value. The current trackability can thus be readily maintained even when the necessary amount of fast decay greatly changes.

As described with reference to FIGS. 10 to 13, the initial value may be zero in the micro-stepping control of the motor 20. The initial value may be a value greater than zero in two-phase control of the motor 20.

In the micro-stepping control, the ratio FastRatio of the fast decay period tFD may be zero because the charging dominates immediately after the target current value crosses zero, so that the fast decay may be small. In the two-phase control, the ratio FastRatio of the fast decay period tFD is set to a value greater than zero because the charging has been performed for a long period immediately after the target current value crosses zero, so that a certain amount of the fast decay is required.

In the present embodiment, the control circuit 120 may include the charge decay control portion 121, which controls the motor driving charging and decay. The charge decay control portion 121 may perform the charging for the period from the start of the charging until the current value detected by the current detection circuit 110 exceeds the target current value of the current IS flowing through the motor 20. The charge decay control portion 121 may control the fast decay and the slow decay by using the fast decay period tFD and the slow decay period tSD based on the ratio FastRatio of the fast decay period tFD.

According to the present embodiment, the charge decay control portion 121 can control the fast decay and the slow decay based on the ratio FastRatio of the fast decay period tFD calculated by the calculation portion 123.

The charge decay control portion 121 may skip the charging before the charging starts and when the current value detected by the current detection circuit 110 exceeds the target current value, as described with reference to FIGS. 14 and 15.

According to the present embodiment, in a situation in which the motor current exceeds the target current value, the PID operation makes the fast decay period tFD zero because the charge period tCHG shortens. Skipping the charging using the feature described above causes the charging not to be performed by only the decay to be performed. The trackability showing how precisely the motor current tracks the target current value can thus be improved.

When the ratio FastRatio of the fast decay period tFD determined in accordance with the charge period tCHG becomes zero, the charge decay control portion 121 may skip the process of controlling the fast decay in the motor driving, as described with reference to FIGS. 16 and 17. When the slow decay period tSD based on the ratio FastRatio of the fast decay period tFD determined in accordance with the charge period tCHG becomes zero, the charge decay control portion 121 may skip the process of controlling the slow decay in the motor driving.

According to the present embodiment, since the fast decay or the slow decay is adaptively skipped based on the PID control, the amount by which the decay is excessive or insufficient can be reduced. Therefore, the trackability showing how precisely the motor current tracks the target current value can be further improved, or the current ripple can be further reduced.

In the present embodiment, out of the given decay period tDT, the calculation portion 123 may set the period of the ratio FastRatio determined in accordance with the charge period tCHG as the fast decay period tFD, and set the period other than the fast decay period tFD as the slow decay period tSD.

According to the present embodiment, the fast decay period tFD and the slow decay period tSD are determined from the ratio FastRatio determined in accordance with the charge period tCHG.

In the present embodiment, the current detection circuit 110 may detect whether the current IS flowing through the motor 20 has reached the target current value. The charge period measurement portion 122 may measure, as the charge time tCHG, the period from the start of the motor driving charging until it is detected that the current IS flowing through the motor 20 has reached the target current value.

According to the present embodiment, the charge period tCHG according to the degree of deviation of the motor current at the start of the charging from the target current value is provided, and the fast decay period tFD is controlled in accordance with the charge period tCHG. Performing such adaptive control of the fast decay period tFD improves the trackability showing how precisely the motor current tracks the target current value, or reduces the current ripple.

In the present embodiment, the motor 20 may be a stepper motor. The drive circuit 150 may be a bridge circuit.

In the present embodiment, the motor control system 300 includes any of the circuit devices 100 described above, and the motor 20.

The present embodiment has been described above in detail, and a person skilled in the art may readily understand that many modifications can be made without substantially departing from the novel items and advantages of the present disclosure. All such modifications therefore fall within the scope of the present disclosure. For example, a term described at least once together with a different term having a broader meaning or the same meaning in the specification or the drawings can be replaced with the different term in any part of the specification or the drawings. All combinations of the present embodiment and the modifications also fall within the scope of the present disclosure. The configurations, operations, and other factors of the current detection circuit, the control circuit, the drive circuit, the circuit device, the motor, the motor control system, and the like are not limited to those described in the present embodiment, and various modifications can be made.

What is claimed is:

1. A circuit device comprising:
a current detection circuit configured to detect a current flowing through a motor; and
a control circuit configured to control a drive circuit configured to drive the motor based on a result of the detection performed by the current detection circuit,
wherein the control circuit includes
a charge period measurement portion configured to measure a charge period in the motor driving performed by the drive circuit, and
a calculation portion configured to calculate a ratio of a fast decay period to a decay period in the motor driving in accordance with the measured charge period.

2. The circuit device according to claim 1, wherein
the calculation portion is configured to increase the ratio of the fast decay period as the charge period shortens.

3. The circuit device according to claim 1, wherein
the calculation portion is configured to calculate the ratio of the fast decay period in accordance with a difference between the charge period and a target period.

4. The circuit device according to claim 3, wherein
the calculation portion is configured to calculate the ratio of the fast decay period in accordance with the difference and a change in the difference.

5. The circuit device according to claim 4, wherein
the calculation portion is configured to calculate the ratio of the fast decay period in accordance with the difference, an accumulated value of the difference, and the change in the difference.

6. The circuit device according to claim 1, wherein
the calculation portion is configured to determine an amount of change in the ratio of the fast decay period from the charge period at an end of the motor driving charging, and update the ratio by adding the amount of change to the ratio previously calculated.

7. The circuit device according to claim 6, wherein
the calculation portion is configured to reset the ratio of the fast decay period to an initial value when a target current value of the current flowing through the motor crosses zero.

8. The circuit device according to claim 7, wherein
the initial value is
zero in micro-stepping control of the motor, and
a value greater than zero in two-phase control of the motor.

9. The circuit device according to claim 1, wherein
the control circuit includes a charge decay control portion configured to control charging and decay in the motor driving,
the charge decay control portion is configured to
perform the charging for a period from start of the charging until a current value detected by the current detection circuit exceeds a target current value of the current flowing through the motor, and
control fast decay and slow decay by using the fast decay period and a slow decay period based on the ratio of the fast decay period.

10. The circuit device according to claim 9, wherein
the charge decay control portion is configured to skip the charging before the start of the charging and when the current value detected by the current detection circuit exceeds the target current value.

11. The circuit device according to claim 9, wherein
the charge decay control portion is configured to
skip the process of controlling the fast decay in the motor driving when the ratio of the fast decay period determined in accordance with the charge period becomes zero, and
skip the process of controlling the slow decay in the motor driving when the slow decay period based on the ratio of the fast decay period determined in accordance with the charge period becomes zero.

12. The circuit device according to claim 1, wherein
out of a given decay period, the calculation portion is configured to set a period of the ratio determined in accordance with the charge period as the fast decay time, and set a period other than the fast decay period as a slow decay period.

13. The circuit device according to claim 1, wherein
the current detection circuit is configured to detect whether the current flowing through the motor reaches a target current value, and
the charge period measurement portion is configured to measure, as the charge period, a period from a start of charging in the motor driving until it is detected that the current flowing through the motor reaches the target current value.

14. The circuit device according to claim 1, wherein
the motor is a stepper motor, and
the drive circuit is a bridge circuit.

15. A motor control system comprising:
the circuit device according to claim 1; and
the motor.
